(19) United States
(12) Patent Application Publication
(10) Pub. No.: US 2020/0310508 A1
(43) Pub. Date: Oct. 1, 2020

(54) CONTROL OF THE POWER SUPPLY OVER A USB TYPE-C BUS

(71) Applicant: STMICROELECTRONICS (GRENOBLE 2) SAS, Grenoble (FR)

(72) Inventors: Cedric FORCE, Saint-Egreve (FR); Thomas ALOFS, Grenoble (FR); Christophe COCHARD, Pontcharra (FR); Olivier SCHULER, Herbeys (FR)

(21) Appl. No.: 16/809,404

(22) Filed: Mar. 4, 2020

(30) Foreign Application Priority Data
Mar. 26, 2019 (FR) 1903167

(51) Int. Cl. G06F 1/30; G06F 13/38; G06F 13/40

(52) U.S. Cl. CPC G06F 1/305; G06F 13/4063; G06F 13/385

(57) ABSTRACT

A power supply generates a power supply signal to provide electric power over a USB type-C bus. The power supply includes temperature sensing circuitry which senses indications of temperature of the power supply. Control circuitry coupled to the power supply circuitry and the temperature sensing circuitry compares indications of temperature sensed by the temperature sensing circuitry to three thresholds. The control circuitry determines a limit on available electric power provided by the power supply circuitry over the USB type-C bus based on the comparing. The limit on available electric power is set to one of three or more power levels based on the comparing.

### BACKGROUND

### Technical Field

The present disclosure generally relates to electronic circuits and, more specifically, to circuits using a universal serial bus (USB) type-C bus.

### Description of the Related Art

The USB type-C bus is an advanced bus capable of conveying different supply powers (voltages and currents) according to the possibilities of the power supply device and to the needs of the device to be powered.

### BRIEF SUMMARY

Since the power supplied by a device to another device over a USB type-C bus may be interrupted according to thermal conditions, there exists a need to improve the continuity of service of the power supply over a USB type-C bus.

An embodiment facilitates overcoming all or part of the disadvantages of known power supply methods and circuits.

An embodiment provides a method of controlling the power supply over a USB type-C bus, wherein an electric power varies according to temperature.

An embodiment provides a circuit of power supply over a USB type-C bus comprising a temperature sensor.

An embodiment provides such circuit, capable of implementing the described method.

An embodiment provides a non-transient storage support comprising instructions capable of implementing the described method.

An embodiment provides a wired logic circuit, capable of implementing the described method.

According to an embodiment, the electric power may take at least three power values.

According to an embodiment, the electric power is supplied by a power supply device to a device to be powered.

According to an embodiment, the electric power is periodically adjusted.

According to an embodiment, an increase in temperature causes an electric power decrease.

According to an embodiment, a decrease in temperature causes an electric power increase.

According to an embodiment, at least one threshold conditions the power variation.

According to an embodiment, at least one threshold conditions a cutting off of the power supply.

The foregoing and other features and advantages will be discussed in detail in the following non-limiting description of specific embodiments in connection with the accompanying drawings.

In an embodiment, a method comprises: sensing a temperature of a power supply; comparing the sensed temperature to a plurality of threshold temperatures, for example, three thresholds; determining a limit on available electric power provided by the power supply based on the comparing, wherein the limit on available electric power is set to one of three or more power levels based on the comparing; and providing, by the power supply, electric power over a USB type-C bus based on the determined limit. In an embodiment, the method comprises: receiving, by a device coupled to the USB type-C bus, electrical power supplied by the power supply. In an embodiment, the method comprises: periodically repeating the sensing of the temperature of the power supply, the comparing of the sensed temperature to the plurality thresholds, and determining of the limit on available electric power. In an embodiment, determining the limit on available electric power is based on previously determined limits on available electric power. In an embodiment, an increase in sensed temperature results in a decrease in power level of the determined limit on available electric power. In an embodiment, a subsequent decrease in sensed temperature results in an increase in power level of the determined limit on available electric power. In an embodiment, the three or more power levels include a nominal power level, a first reduced power level lower than the nominal power level and a second reduced power level lower than the first reduced power level. In an embodiment, the three or more power levels include a zero power level in which no power is made available by the power supply.

In an embodiment, a device comprises: power supply circuitry, which, in operation, generates a power supply signal to provide electric power over a USB type-C bus; temperature sensing circuitry, which, in operation, senses indications of temperature of the power supply circuitry; and control circuitry coupled to the power supply circuitry and the temperature sensing circuitry, wherein the control circuitry, in operation, compares indications of temperature sensed by the temperature sensing circuitry to three thresholds; and determines a limit on available electric power provided by the power supply circuitry over the USB type-C bus based on the comparing, wherein the limit on available electric power is set to one of three or more power levels based on the comparing. In an embodiment, the device comprises a USB type-C bus interface coupled to the power supply circuitry. In an embodiment, the control circuitry, in operation, periodically compares indications of temperature sensed by the temperature sensing circuitry to the plurality thresholds, and adjusts the limit on available electric power. In an embodiment, the control circuitry, in operation, adjusts the limit on available electric power based on previously determined limits on available electric power. In an embodiment, an increase in sensed temperature indications results in a decrease in power level of the determined limit on available electric power. In an embodiment, a subsequent decrease in sensed temperature indications results in an increase in power level of the determined limit on available electric power. In an embodiment, the three or more power levels include a nominal power level, a first reduced power level lower than the nominal power level and a second reduced power level lower than the first reduced power level. In an embodiment, the three or more power levels include a zero power level in which no power is made available by the power supply.

In an embodiment, a system comprises: a power supply, having: power supply circuitry, which, in operation, generates a power supply signal; temperature sensing circuitry, which, in operation, senses indications of temperature of the power supply circuitry; and control circuitry coupled to the power supply circuitry and the temperature sensing circuitry, wherein the control circuitry, in operation, compares indications of temperature sensed by the temperature sensing circuitry to three thresholds; and determines a limit on available electric power provided by the power supply circuitry based on the comparing, wherein the limit on available electric power is set to one of three or more power levels based on the comparing; and a USB type-C interface, which, in operation, receives the power supply signal. In an embodiment, the system comprises: a device, which, in operation, couples to the power supply via the USB type-C interface.

In an embodiment, a non-transitory computer-readable medium's contents which configure a power supply to perform a method, the method, comprising: sensing a temperature of the power supply; comparing the sensed temperature to three threshold temperatures; determining a limit on available electric power provided by the power supply based on the comparing, wherein the limit on available electric power is set to one of three or more power levels based on the comparing; and providing, by the power supply, electric power over a USB type-C bus based on the determined limit. In an embodiment, the power supply comprises processing circuitry and the contents comprise instructions which, when executed by the processing circuitry, cause the power supply to perform the method. In an embodiment, the method comprises: periodically repeating the sensing of the temperature of the power supply, the comparing of the sensed temperature to the plurality thresholds, and determining of the limit on available electric power. In an embodiment, the determining the limit on available electric power is based on previously determined limits on available electric power. In an embodiment, the three or more power levels include a nominal power level, a first reduced power level lower than the nominal power level and a second reduced power level lower than the first reduced power level. In an embodiment, the three or more power levels include a zero power level in which no power is made available by the power supply.

### BRIEF DESCRIPTION OF THE DRAWINGS

FIG. 1 schematically shows an example of pinout of a USB type-C connector;

FIG. 2 very schematically shows, in the form of blocks, an embodiment of a system of control of the power supply over a USB type-C bus;

FIG. 3 is a flow diagram of operations associated with the establishing of a configuration of power supply over a USB type-C bus of an embodiment;

FIG. 4 is a flow diagram of an embodiment of operations associated with the establishing of a configuration of power supply over a USB type-C bus;

FIG. 5 is a flow diagram of another embodiment of operations associated with the establishing of a configuration of power supply over a USB type-C bus;

FIG. 6 shows timing diagrams illustrating an example of control, according to temperature, of an electric power supplied by a power supply device to a device to be powered;

FIG. 7 shows an example of a system implementing a power supply control; and

FIG. 8 shows another example of a system implementing a power supply control.

### DETAILED DESCRIPTION

The same elements have been designated with the same reference numerals in the different drawings. In particular, the structural and/or functional elements common to the different embodiments may be designated with the same reference numerals and may have identical structural, dimensional, and material properties.

For clarity, only those steps and elements which are useful to the understanding of the described embodiments have been shown and are detailed. In particular, the generation of the signals according to the data to be transmitted over a USB type-C bus and the reception of these signals by a reception circuit have not been detailed, the described embodiments being compatible with usual transmissions between two or a plurality of circuits over a USB type-C bus.

Throughout the present disclosure, the term “connected” is used to designate a direct electrical connection between circuit elements with no intermediate elements other than conductors, whereas the term “coupled” is used to designate an electrical connection between circuit elements that may be direct, or may be via one or more intermediate elements.

In the following description, when reference is made to terms qualifying absolute positions, such as terms “front”, “back”, “top”, “bottom”, “left”, “right”, etc., or relative positions, such as terms “above”, “under”, “upper”, “lower”, etc., or to terms qualifying directions, such as terms “horizontal”, “vertical”, etc., unless otherwise specified, it is referred to the orientation of the drawings.

The terms “about”, “substantially”, and “approximately” are used herein to designate a tolerance of plus or minus 10%, preferably of plus or minus 5%, of the value in question.

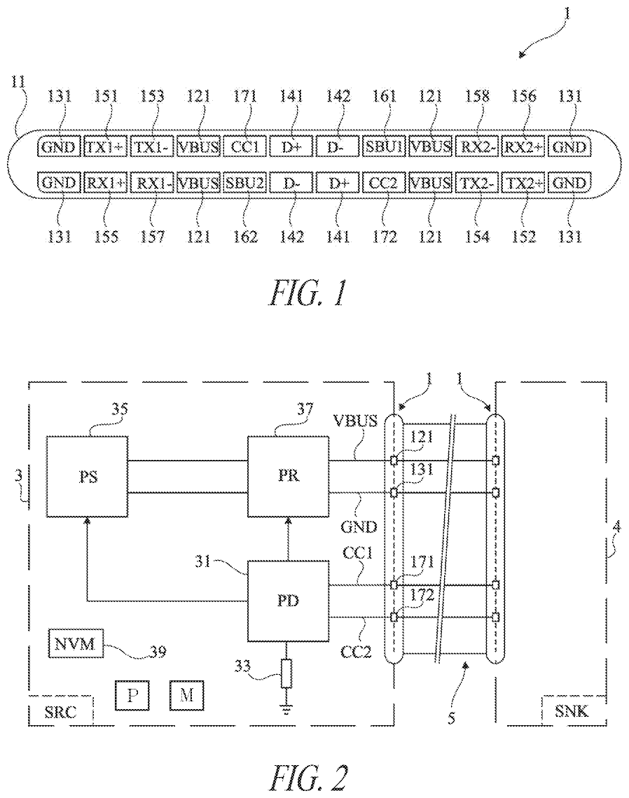

FIG. 1 schematically shows an example of pinout of a USB type-C connector.

A USB type-C connector or interface 1 is formed, in standardized fashion, of a body 11 comprising at most twenty-four pins: four power supply pins 121 (VBUS);
four potential reference pins 131 (GND);
four differential transmit pins, including two positive pins 141 (D+) and two negative pins 142 (D−);
eight other differential transmit pins, including two positive transmit pins 151, 152 (TX1+, TX2+), two negative transmit pins 153, 154 (TX1−, TX2−), two positive receive pins 155, 156 (RX1+, RX2+), and two negative receive pins 157, 158 (RX1−, RX2−);
two auxiliary communication pins 161, 162 (SBU1, SBU2); and
two configuration pins 171, 172 (CC1, CC2).

FIG. 2 schematically shows in the form of blocks an embodiment of a system of control of the power supply over a USB type-C bus.

According to this embodiment, a power supply device 3 (or source (SRC) is coupled, in an embodiment, connected, to a device 4 (SNK) to be powered (sink) via a cable 5 compatible with a transmission respecting the USB type-C protocol. Devices 3 and 4 both comprise a connector or interface 1. The pins of the two connectors are coupled, in an embodiment connected, to conductors or wires, forming the bus, capable of conveying signals between devices 3 and 4.

The USB type-C bus provides that, by default, device 3 supplies device 4 with a 15-watt power (P) under a 5-volt voltage. However, device 4 sometimes requires a power P greater than 15 watts. In certain cases, a different power supply configuration may be established between devices 3 and 4.

The establishing, between devices 3 and 4, of a power supply configuration involves an exchange of data called PDO (Power Data Object). PDOs contain, in particular, voltage values and current values. On the side of device 3, the PDOs are characteristic of power supply capacities. On the side of device 4, the PDOs are representative of power needs.

Device 3 comprises a power supply control circuit 31 (PD). Circuit 31 is coupled, in an embodiment connected:
to pins 171 (CC1) and 172 (CC2) of connector 1;
to a temperature sensor 33 (for example, a thermistor probe with a negative temperature coefficient—NTC);
to a power supply source 35 (PS) (for example, a switched-mode power supply or a battery); and
to a power regulation circuit 37 (PR).

Circuit 3 also comprises, for example, a non-volatile memory 39 (NVM) and other circuits/memories and/or functions depending on the application.

Circuit 31 of device 3 imposes a voltage set point to source 35. This voltage set point typically originates from a PDO resulting from the establishing of a power supply configuration between devices 3 and 4. The corresponding voltage is applied, by source 35, between terminals 121 and 131 of connector 1 of device 3.

Circuit 31 of device 3 imposes a current set point to circuit 37. This current set point typically originates from a PDO resulting from the establishing of a power supply configuration between devices 3 and 4. The corresponding current is supplied to device 4 via wires VBUS, GND respectively connected to terminals 121, 131 of connector 1 of device 3.

According to an embodiment, the current set point imposed to circuit 37 of device 3 is conditioned by the temperature (T) measured by sensor 33. Circuit 31 of device 3 is thus capable of controlling, at a constant voltage, the electric power P delivered to device 4 according to temperature T.

The USB type-C protocol provides that a PDO comprises:
a header, typically coded over 10 bits;
a nominal voltage value, typically coded over 10 bits; and
a nominal current value, typically coded over 10 bits.

According to an embodiment, the values of the currents of the PDO are defined for a nominal current value and a second current value, called OTP current value. The OTP current value is capable of modifying the power delivered by device 3 according to the temperature measured by sensor 33.

According to an embodiment, it may be provided for the functionalities of circuits 31, 35 and 37 to be implemented:
by a computer program product; and/or
by a wired logic circuit carrying out the functions of circuits 31, 35 and/or 37; and/or
by a combined circuit combining hardware and software.

In the case of a software embodiment, instructions executable by a processor P (e.g., one or more processing cores) contained by device 3 are stored, for example, in non-transient fashion in a volatile memory M, or a non-volatile memory, for example, memory 39.

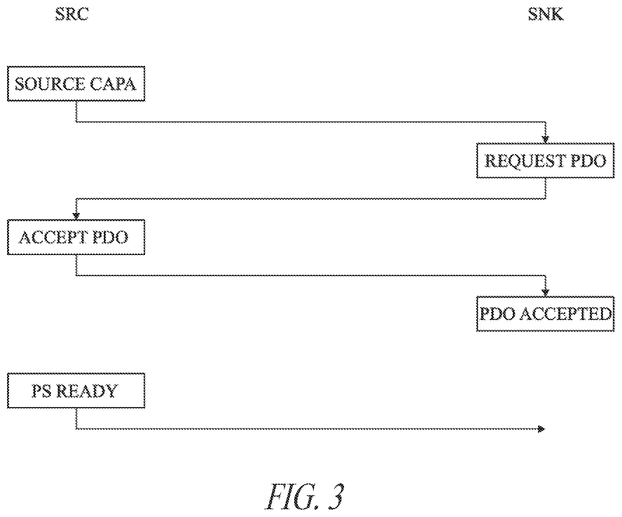

FIG. 3 is a flow diagram of operations associated with the establishing of a power supply configuration over a USB type-C bus.

The establishing of a power supply configuration starts by the sending, by the power supply device (SRC) to the device to be supplied (SNK), of a message (SOURCE CAPA). This message typically contains five PDOs characteristic of power supply capacities of device SRC. Device SNK then sends back to device SRC a request (REQUEST PDO). The request typically contains a PDO representative of the power needs of device SNK.

If request REQUEST PDO is accepted (ACCEPT PDO) by device SRC, a confirmation (PDO ACCEPTED) is sent to device SNK. Device SRC then sends to device

SNK a state message (PS READY) indicating that the power supply will start. Device SRC then supplies device SNK with an electric power corresponding to current and voltage values contained in request REQUEST PDO.

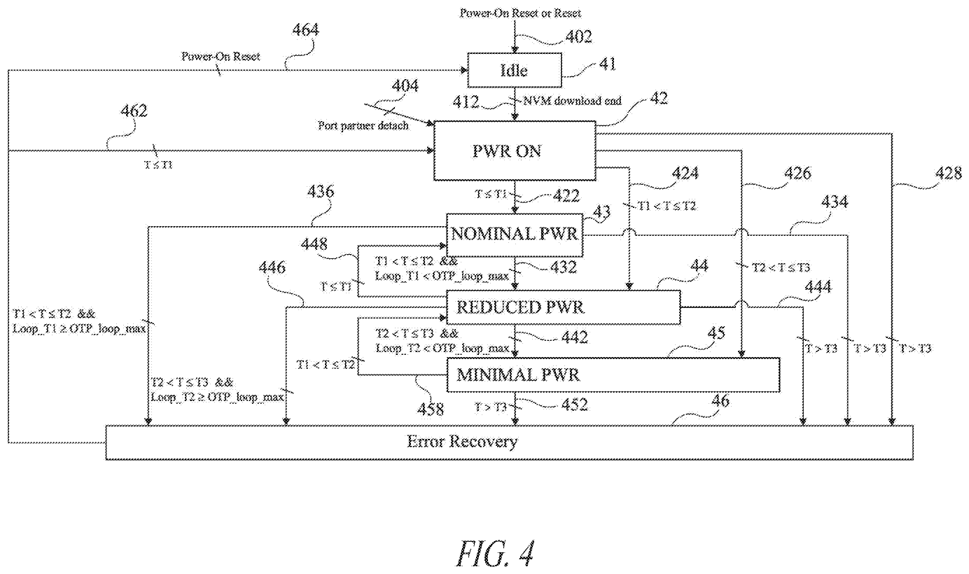

FIG. 4 is a flow diagram of an embodiment of operations associated with establishing of a power supply configuration over a USB type-C bus when temperature is changing.

According to this embodiment, a powering on (link 402, Power-On Reset or Reset) of a power supply device SRC is followed by an initialization step (block 41, Idle). Step 41 ends with a downloading (link 412, NVM download end) of data contained in a non-volatile storage memory 39 (NVM, FIG. 2). The data typically are PDOs characteristic of the power supply capacities of the SRC device. Such PDOs may comprise an OTP current value smaller than the value of the nominal current capable of being supplied by device SRC. Once the PDOs have been downloaded from memory 39, device SRC enters a phase (block 42, PWR ON) where it waits for the connection of a device SNK to be powered.

The connection of a device SNK to device SRC causes the establishing of a first power supply configuration as discussed in relation with FIG. 3. The establishing of the power supply configuration thus involves an exchange of PDOs between the two paired devices. According to the embodiment of FIG. 4, the PDOs provided by device SRC to device SNK vary according to temperature T. In other words, the power supply capacities of device SRC are conditioned by the measurement of temperature T.

According to an embodiment, temperature T is compared with three temperature thresholds (T1, T2, T3). The values of thresholds T1, T2, T3 are defined so that T1<T2<T3.

On completion of the establishing of the first power supply configuration (or initial power supply configuration), the power supply capacities of device SRC are determined according to the value of temperature T with respect to the three thresholds:
if T<T1 (link 422), the power supply capacity of device SRC is maximum, device SNK then having access to a nominal power (block 43, NOMINAL PWR) corresponding to the product of the nominal voltage by the nominal current;
if T1<T<T2 (link 424), the power supply capacity of device SRC is decreased, device SNK then having access to a reduced power (block 44, REDUCED PWR) typically corresponding to the product of the nominal voltage by current OTP;
if T2<T<T3 (link 426), the power supply capacity of device SRC is more restricted, device SNK then having access to a minimum power (block 45, MINIMAL PWR) typically corresponding to the product of the nominal voltage by a portion of 50% of the OTP current; and
if T>T3 (link 428), the power supply to device SNK is interrupted by a switching to the error recovery mode (block 46, Error Recovery) of device SRC. From this error recovery mode, the connection of a device SNK is no longer possible.

According to an embodiment, other power supply configurations are capable of being established a plurality of times during a period when devices SRC and SNK are paired. One of the functionalities of the USB type-C bus indeed is to enable to establish power supply configurations at any time. Advantage is thus taken of this functionality to adjust power P, supplied by device SRC, according to possible variations of temperature T with respect to thresholds T1, T2, T3. Thus, according to the variations of temperature T, the power P supplied by device SRC can in turns take values NOMINAL PWR, REDUCED PWR, and MINIMAL PWR, except in the case where threshold T3 is exceeded, the power supply of device SNK then being interrupted.

According to an embodiment, the power supply configurations are established both at the moment when device SNK is connected and outside the periods of data transmission over the USB type-C bus. This allows to respect the atomicity of the sequences of messages, which are clocked at a 32 kHz frequency (that is to say about every 30 μs).

In the example of FIG. 4, two counters are respectively capable of recording:
a number (Loop_T1) of cycles during which the power varies from NOMINAL PWR to REDUCED PWR, and then from REDUCED PWR to NOMINAL PWR; and
a number (Loop_T2) of cycles during which the power varies from REDUCED PWR to MINIMAL PWR, and then from MINIMAL PWR to REDUCED PWR.

When one of the counters reaches or exceeds a defined threshold (OTP loop max), device SRC is then directly switched to the error recovery mode (block 46).

From block 43, the establishing of a new power supply configuration results in re-estimating the power supply capacity of device SRC according to the value of temperature T:
if T<T1, the power capable of being delivered by device SRC remains unchanged, device SNK still having access to power NOMINAL PWR;
if T1<T<T2 and Loop_T1<OTP loop max (link 432), the power capable of being delivered by device SRC is decreased to value REDUCED PWR;
if T>T3 (link 434), the power supply to device SNK is interrupted by a switching to the error recovery mode (in practice, this should never happen because temperature T will rise above threshold T2 before exceeding threshold T3); and
if T1<T<T2 and Loop_T1>OTP loop max (link 436), the power supply to device SNK is interrupted by a switching to the error recovery mode.

From block 44, the establishing of a new power supply configuration results in re-estimating the power supply capacity of device SRC according to the value of temperature T:
if T1<T<T2, the power capable of being delivered by device SRC remains unchanged, device SNK still having access to power REDUCED PWR;

if T2<T<T3 and Loop_T2<OTP loop max (link 442), the power capable of being delivered by device SRC is decreased to value MINIMAL PWR; if T>T3 (link 444), the power supply to device SNK is interrupted by a switching to the error recovery mode (in practice, this should never happen because temperature T will rise above threshold T2 before exceeding threshold T3);
if T2<T<T3 and Loop_T2>OTP loop max (link 446), the power supply to device SNK is interrupted by a switching to the error recovery mode; and
if T<T1 (link 448), the power capable of being delivered by device SRC is raised to value NOMINAL PWR and counter Loop_T1 is incremented by one unit.

From block 45, the establishing of a new power supply configuration results in re-estimating the power supply capacity of device SRC according to the value of temperature T:
if T2<T<T3, the power capable of being delivered by device SRC remains unchanged, device SNK still having access to power MINIMAL PWR;
if T>T3 (link 452), the power supply to device SNK is interrupted by a switching to the error recovery mode; and
if T1<T<T1 (link 458), the power capable of being delivered by device SRC is raised to value REDUCED PWR and counter Loop_T2 is incremented by one unit.

It is possible to leave the error recovery mode:

if T<T1 (link 462), such a transition being possible in an embodiment only once; or
if the power supply of device SRC is cut off (link 464, Power-On Reset).

From any of blocks 42, 43, 44, 45, any disconnection of device SNK to be powered results in switching back, via link 404, to mode PWR ON (block 42).

According to an embodiment, counters Loop_T1, Loop_T2 are reset:
when device SNK is disconnected from device SRC; and/or
at the end of a defined duration, for example, after ten hours of operation.

In a similar way, the error recovery mode, which may in an embodiment be left only once if T<T1 (link 462), could also be left according to a defined periodicity, for example, after ten hours of operation.

The adjustment of the power delivered during the power supply enables to decrease cases of possible overheating and to thus avoid a runaway of the temperature of device SRC, which usually results in a power shutdown.

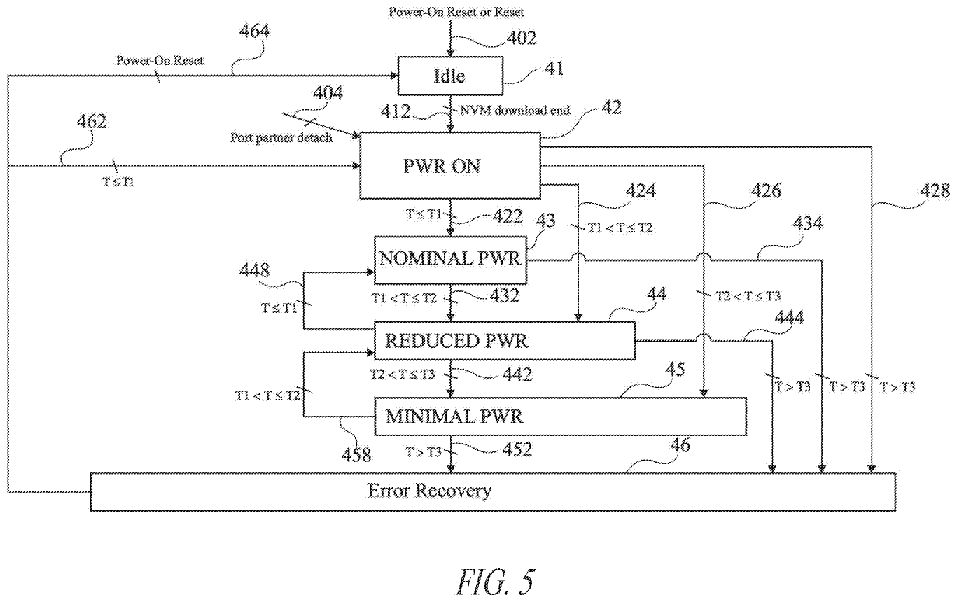

FIG. 5 is a flow diagram of another embodiment of operations associated with establishing of a power supply configuration over a USB type-C bus when temperature is changing.

According to this embodiment, the power supply capacities of device SRC may be adjusted, according to temperature variations, with no limits in the number of transitions between powers NOMINAL PWR, REDUCED PWR, MINIMAL PWR. As compared with FIG. 4, links 436, 446 are suppressed and links 432, 442 no longer take into account counters Loop_T1, Loop_T2, or threshold OTP loop max.

Thus, only an increase in temperature T resulting in the exceeding of threshold T3 is capable of causing a power shutdown by switching to the error recovery mode. This further increases the availability of device SRC.

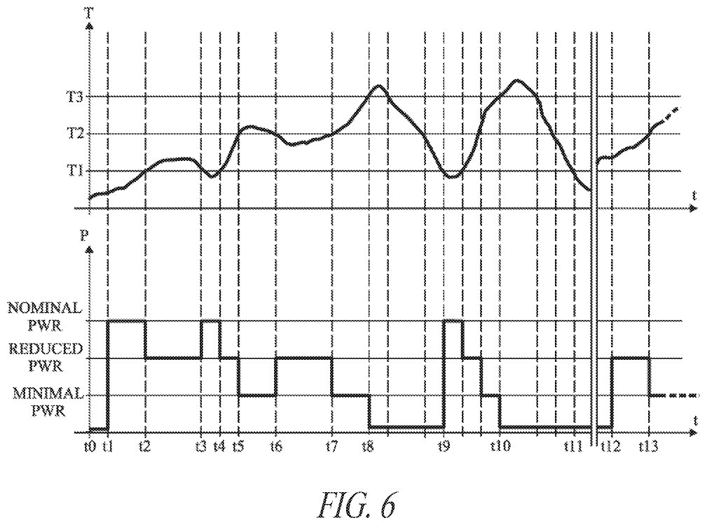

FIG. 6 shows timing diagrams illustrating an example of control, according to temperature, of electric power supplied by a power supply device to a device to be powered.

At a time t0, temperature T is lower than threshold T1 and device SNK is not connected yet to device SRC. No power is delivered by device SRC.

At a time t1, device SNK is connected, or paired, to device SRC. A first power supply configuration is then established. Temperature T still being smaller than threshold T1, device SRC delivers a power P typically corresponding to the nominal power (NOMINAL PWR) of device SRC.

At a time t2, temperature T rises above threshold T1. A new power configuration is established. Device SRC then delivers a reduced power (REDUCED PWR).

At a time t3, temperature T falls below threshold T1. A new power configuration is established and device SRC delivers the nominal power.

At a time t4, temperature T rises above threshold T1. The power thus decreases from NOMINAL PWR to REDUCED PWR.

At a time t5, temperature T rises above threshold T2. A new power configuration is established. Device SRC then delivers a minimum power (MINIMAL PWR).

At a time t6, temperature T falls below threshold T2 and power P increases from MINIMAL PWR to REDUCED PWR.

At a time t7, temperature T rises above threshold T2 and power P decreases from REDUCED PWR to MINIMAL PWR.

At a time t8, temperature T rises above threshold T3, thus causing a switching of device SRC to the error recovery mode. The power delivery to device SNK is stopped and the connection of a new device SNK is no longer possible until a time t9 when temperature T falls below threshold T1. Threshold T3 having being crossed only once, the nominal power (NOMINAL PWR) is restored by device SRC.

At a time t10, temperature T rises above threshold T3, causing again the switching of device SRC to the error recovery mode. This time, no power is delivered by device SRC as long as the power supply to device SRC has not been shut down or as long as a predefined time period has elapsed.

At a time tl l when the temperature falls back below threshold T1, the nominal power is thus not restored by device SRC.

It is assumed that a predefined time period has elapsed between time tl l and a time t12 when device SNK is connected back to device SRC. Temperature T being, at this time t12, between thresholds T1 and T2, device SRC provides device SNK with a reduced power (REDUCED PWR). Such a situation may occur if the circuit heats up even if it is disconnected.

At a time t13, temperature T rises above threshold T2. A new power configuration is established. The power delivered by device SRC then decreases from REDUCED PWR to MINIMAL PWR. Thus, the power delivered by device SRC is adjusted, according to temperature variations, to enable to optimize the continuity of service.

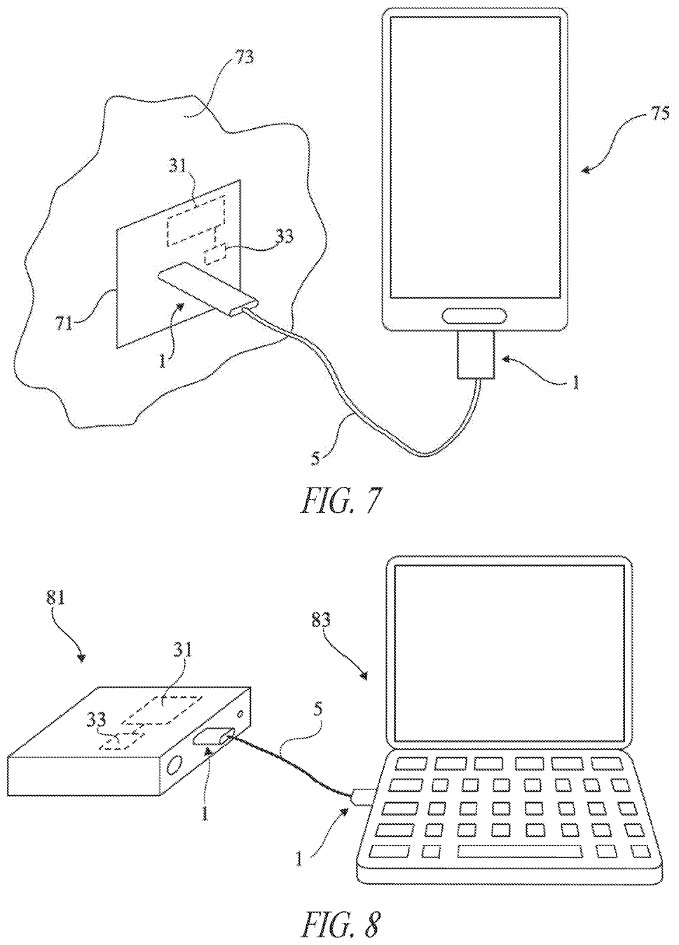

FIG. 7 shows an example of a system implementing a power control.

In the example of FIG. 7, a wall socket 71 affixed to a wall 73 comprises a circuit 31 coupled to a temperature sensor 33. Equipment 75 to be powered (for example, a touch pad or a smart phone) is connected to wall socket 71 via a cable 5 compatible with a transmission respecting the USB type-C protocol. Cable 5 comprises two connectors 1, one connected to wall socket 71 and the other connected to equipment 75. Circuit 31 is capable of controlling the power delivered by wall socket 71 to equipment 75 according to a temperature measured by sensor 33.

FIG. 8 shows another example of a system implementing a power control.

In the example of FIG. 8, a battery 81 or energy store contains a circuit 31 coupled to a temperature sensor 33. Equipment 83 to be powered (for example, a laptop computer) is connected to battery 81 via a cable compatible with a transmission respecting the USB type-C protocol. Cable 5 comprises two connectors 1 connected, one to battery 81 and the other to equipment 83. Circuit 31 is capable of controlling the power delivered by battery 81 to equipment 83 according to a temperature measured by sensor 33.

In the example of FIG. 8, battery 81 plays the role of the power supply device (SRC) while laptop computer 83 plays the role of the device to be powered (SNK).

An inverse configuration may however be envisaged, where laptop computer 83 for example, enables to recharge battery 81. In such a case, the USB type-C link operates in “dual” mode.

Various embodiments and variations have been described. Those skilled in the art will understand that certain features of these various embodiments and variations may be combined, and other variations will occur to those skilled in the art. In particular, what is more particularly disclosed in relation with an example of application to a control of the power supply of equipment by a wall socket or by a battery more generally applies to any control of the power supply, by a power supply device, of a device to be powered.

Finally, the practical implementation of the described embodiments and variations is within the abilities of those skilled in the art based on the functional indications given hereabove. In particular, although the described embodiments more particularly refer to a system where the functions of the power supply device and of devices to be powered are set, it is within the abilities of those skilled in the art, based on the above description, to transpose the described embodiments to a system where all the devices may play the role of a power supply device or of a device to be powered.

Such alterations, modifications, and improvements are intended to be part of this disclosure, and are intended to be within the spirit and the scope of the present disclosure. Accordingly, the foregoing description is by way of example only and is not intended to be limiting.

Some embodiments may take the form of or comprise computer program products. For example, according to one embodiment there is provided a computer readable medium comprising a computer program adapted to perform one or more of the methods or functions described above. The medium may be a physical storage medium, such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the methods and/or functionality may be implemented or provided in other manners, such as at least partially in firmware and/or hardware, including, but not limited to, one or more application-specific integrated circuits (ASICs), digital signal processors, discrete circuitry, logic gates, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
sensing a temperature of a power supply;
comparing the sensed temperature to three threshold temperatures;
determining a limit on available electric power provided by the power supply based on the comparing, wherein the limit on available electric power is set to one of three or more power levels based on the comparing; and
providing, by the power supply, electric power over a USB type-C bus based on the determined limit.

2. The method of claim 1, comprising:
receiving, by a device coupled to the USB type-C bus, electrical power supplied by the power supply.

3. The method of claim 1, comprising:
periodically repeating the sensing of the temperature of the power supply, the comparing of the sensed temperature to the plurality thresholds, and determining of the limit on available electric power.

4. The method of claim 3 wherein the determining the limit on available electric power is based on previously determined limits on available electric power.

5. The method of claim 3 wherein an increase in sensed temperature results in a decrease in power level of the determined limit on available electric power.

6. The method of claim 5 wherein a subsequent decrease in sensed temperature results in an increase in power level of the determined limit on available electric power.

7. The method of claim 1 wherein the three or more power levels include a nominal power level, a first reduced power level lower than the nominal power level and a second reduced power level lower than the first reduced power level.

8. The method of claim 7 wherein the three or more power levels include a zero power level in which no power is made available by the power supply.

9. A device, comprising:
power supply circuitry, which, in operation, generates a power supply signal to provide electric power over a USB type-C bus;
temperature sensing circuitry, which, in operation, senses indications of temperature of the power supply circuitry; and
control circuitry coupled to the power supply circuitry and the temperature sensing circuitry, wherein the control circuitry, in operation,
compares indications of temperature sensed by the temperature sensing circuitry to three thresholds; and
determines a limit on available electric power provided by the power supply circuitry over the USB type-C bus based on the comparing, wherein the limit on available electric power is set to one of three or more power levels based on the comparing.

10. The device of claim 9, comprising a USB type-C bus interface coupled to the power supply circuitry.

11. The device of claim 9 wherein the control circuitry, in operation, periodically compares indications of temperature sensed by the temperature sensing circuitry to the plurality thresholds, and adjusts the limit on available electric power.

12. The device of claim 11 wherein the control circuitry, in operation, adjusts the limit on available electric power based on previously determined limits on available electric power.

13. The device of claim 11 wherein an increase in sensed temperature indications results in a decrease in power level of the determined limit on available electric power.

14. The device of claim 13 wherein a subsequent decrease in sensed temperature indications results in an increase in power level of the determined limit on available electric power.

15. The device of claim 9 wherein the three or more power levels include a nominal power level, a first reduced power level lower than the nominal power level and a second reduced power level lower than the first reduced power level.

16. The device of claim 15 wherein the three or more power levels include a zero power level in which no power is made available by the power supply.

17. A system, comprising:
a power supply, having:
power supply circuitry, which, in operation, generates a power supply signal;
temperature sensing circuitry, which, in operation, senses indications of temperature of the power supply circuitry; and
control circuitry coupled to the power supply circuitry and the temperature sensing circuitry, wherein the control circuitry, in operation,
compares indications of temperature sensed by the temperature sensing circuitry to three thresholds; and
determines a limit on available electric power provided by the power supply circuitry based on the comparing, wherein the limit on available electric power is set to one of three or more power levels based on the comparing; and
a USB type-C interface, which, in operation, receives the power supply signal.

18. The system of claim 17, comprising:
a device, which, in operation, couples to the power supply via the USB type-C interface.

19. A non-transitory computer-readable medium having contents which configure a power supply to perform a method, the method, comprising:
sensing a temperature of the power supply;
comparing the sensed temperature to three threshold temperatures;
determining a limit on available electric power provided by the power supply based on the comparing, wherein the limit on available electric power is set to one of three or more power levels based on the comparing; and
providing, by the power supply, electric power over a USB type-C bus based on the determined limit.

20. The non-transitory computer-readable medium of claim 19 wherein the power supply comprises processing circuitry and the contents comprise instructions which, when executed by the processing circuitry, cause the power supply to perform the method.

21. The non-transitory computer-readable medium of claim 19 wherein the method comprises:
periodically repeating the sensing of the temperature of the power supply, the comparing of the sensed temperature to the plurality thresholds, and determining of the limit on available electric power.

22. The non-transitory computer-readable medium of claim 21 wherein the determining the limit on available electric power is based on previously determined limits on available electric power.

23. The non-transitory computer-readable medium of claim 19 wherein the three or more power levels include a nominal power level, a first reduced power level lower than the nominal power level and a second reduced power level lower than the first reduced power level.

24. The non-transitory computer-readable medium of claim 23 wherein the three or more power levels include a zero power level in which no power is made available by the power supply.
